(19) United States
(12) Patent Application Publication
(10) Pub. No.: US 2009/0267381 A1
(43) Pub. Date: Oct. 29, 2009

(54) TRAILER ASSEMBLY WITH COVER AND LIFT MECHANISM

(75) Inventors: Rick Huddleston, Gassville, AR (US); Ronald Sahr, Little Falls, MN (US)

Correspondence Address: MERCHANT & GOULD PC, P.O. BOX 2903, MINNEAPOLIS, MN, 55402-0903, US

(73) Assignee: Genmar Minnesota, Inc., Little Falls, MN (US)

(21) Appl. No.: 12/429,308

(22) Filed: Apr. 24, 2009

Related U.S. Application Data
(60) Provisional application No. 61/048,510, filed on Apr. 28, 2008.

(51) Int. Cl. B60J 7/08; B63B 17/00

(52) U.S. Cl. 296/100.08; 114/361

(57) ABSTRACT

A trailer assembly includes a cover assembly having a cover and a frame assembly engaged with the cover assembly. The frame assembly includes a frame and a lifting arm having a first end engaged to the frame and a second end engaged to the cover. The lifting arm is selectively laterally extendable from the frame.

This application claims the benefit of U.S. Provisional Patent Application Ser. No. 61/048,510, entitled “TRAILER ASSEMBLY WITH COVER AND LIFT MECHANISM” and filed Apr. 28, 2008, which is hereby incorporated by reference in its entirety.

### BACKGROUND

### Background

Recreation boats are used on many different occasions and for many different activities including, but not limited to, fishing, water skiing, racing, etc. As many users and owners of recreational boats do not live on waterfront property, trailers are often used to transport these boats to a water location, including but not limited to rivers, lakes, etc. for use. However, many trailers that are commercially available do not protect the interior of the boat as the boat is being transported.

### SUMMARY

An aspect of the present disclosure relates to a trailer assembly having a cover assembly and a frame assembly engaged with the cover assembly.

Another aspect of the present disclosure relates to a trailer assembly including a cover assembly having a cover and a frame assembly engaged with the cover assembly. The frame assembly includes a frame and a lifting arm having a first end engaged to the frame and a second end engaged to the cover. The lifting arm is selectively laterally extendable from the frame.

Another aspect of the present disclosure relates to a cover assembly for covering a boat. The cover assembly includes a first portion having a top wall and a plurality of sides. The top wall and the plurality of sides cooperatively define a cavity that is adapted to receive a top portion of a boat. The first portion is made of a material that is self-supporting. A second portion of the cover assembly includes an outer portion and an inner portion. The outer portion is engaged to the plurality of sides of the first portion and the inner portion is adapted for engagement with a hull of a boat. The second portion is made of a material having a stiffness that is less than the stiffness of the material of the first portion.

Another aspect of the present disclosure relates to a method for raising a cover of a trailer assembly. The method includes raising a cover assembly in a linear direction relative to a frame assembly and pivoting the cover assembly about a forward end of the cover assembly.

Another aspect of the present disclosure relates to a method of supplying a cover to a consumer. The method includes receiving a boat with a cover and offering a consumer with opportunities to purchase the cover, purchase the cover and a frame assembly for a trailer assembly and returning the cover.

Another aspect of the present disclosure relates to a method for latching a cover of a trailer assembly. The method includes removing a seat post of a seat from a seat post receptacle on a boat. A catch is inserted into the seat post receptacle on the boat. The cover is lowered so that a latch mechanism engages the catch.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is an isometric view of a trailer assembly having exemplary features of aspects in accordance with the principles of the present disclosure.

FIG. 2 is an isometric view of the trailer assembly of FIG. 1 with a cover assembly in a lowered position.

FIG. 3 is an isometric view of an underside of the trailer assembly of FIG. 1.

FIG. 4 is an isometric view of a cover suitable for use with the trailer assembly of FIG. 1.

FIG. 5 is an isometric view of an underside of the cover of FIG. 4.

FIG. 6 is an isometric, fragmentary view of a front portion of a frame assembly of the trailer assembly of FIG. 1.

FIG. 7 is an isometric, fragmentary view of a lock on a lifting arm of a first plurality of lifting arms suitable for use with the trailer assembly of FIG. 1.

FIG. 8 is an isometric, fragmentary, exploded view of one of a second plurality of lifting arms suitable for use with the trailer assembly of FIG. 1.

FIG. 9 is a front view of the trailer assembly of FIG. 1 with the second plurality of lifting arms in a towing position.

FIG. 10 is a front view of the trailer assembly of FIG. 1 with the second plurality of lifting arms in a loading position.

FIG. 11 is an isometric view of one of the second plurality of lifting arms in the towing position.

FIG. 12 is an isometric view of one of the second plurality of lifting arms in the loading position.

FIG. 13 is an isometric view of the underside of the cover assembly with a latch mechanism suitable for use with the trailer assembly of FIG. 1.

FIG. 14 is an isometric view of the latch mechanism of FIG. 13.

FIG. 15 is an isometric view of a catch suitable for use with the latch mechanism of FIG. 13.

FIG. 16 is a representation of a method for raising a cover assembly of a trailer assembly.

FIG. 17 is a representation of a method for lowering the cover assembly of a trailer assembly.

FIG. 18 is a representation of a method for supplying a cover to a consumer.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

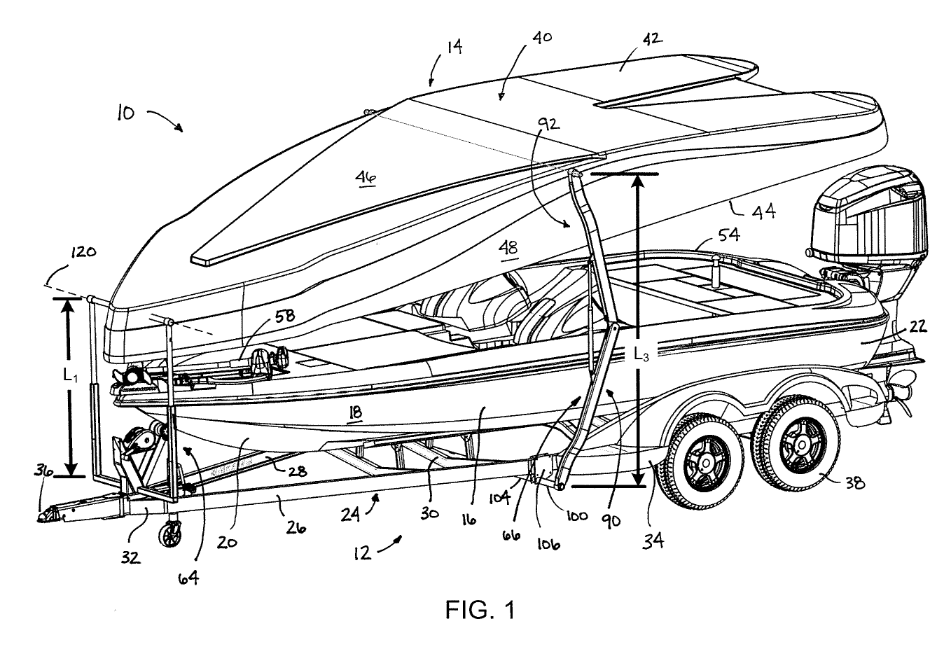

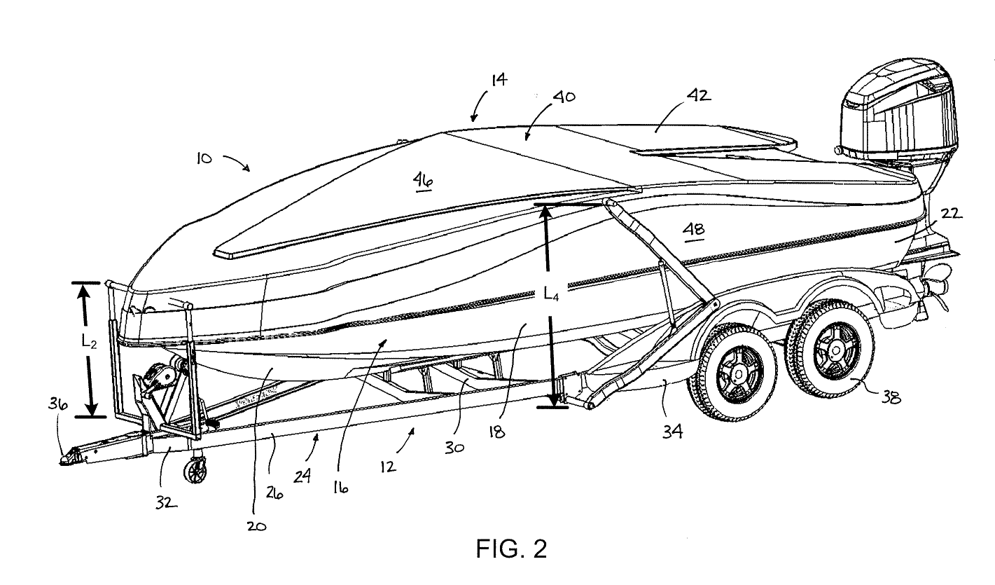

Referring now to FIGS. 1 and 2, a trailer assembly, generally designated 10, is shown. The trailer assembly 10 includes a frame assembly, generally designated 12, and a cover assembly, generally designated 14. In the subject embodiment, the trailer assembly 10 is adapted to receive a water vehicle, generally designated 16, such as a boat. In the subject embodiment, the boat 16 includes a hull 18 having a forward end or a bow 20 and a rear end or aft end 22.

The frame assembly 12 includes a frame, generally designated 24, having a first side 26 and a second side 28. The frame 24 includes a plurality of cross-bars 30 that extends between the first and second sides 26, 28 of the frame 24. The cross-bars 30 provide structural support for the frame assembly 12.

The frame 24 further includes a first end portion 32 and a second end portion 34. In the subject embodiment, the first end portion 32 includes a hitch assembly 36. The hitch assembly 36 is adapted for connected engagement with a trailer hitch (e.g., ball hitch) on a vehicle for towing the trailer assembly 10 to/from the water location.

In one embodiment, the frame assembly 12 includes a plurality of skids or rollers are mounted to the frame 24. The plurality of skids or rollers are adapted to provide sliding or rolling contact with the hull 18 of the boat 16 to allow for lower frictional contact between the frame assembly 12 and the boat 16 as the boat 16 is being loaded and unloaded onto the trailer assembly 10.

The second end portion 34 includes a plurality of wheels 38 for use in transporting the trailer assembly 10 to/from a water location, such as a lake. The second end portion 34 of the trailer assembly 10 is adapted to receive the boat 16. With the boat 16 disposed on the trailer assembly 10, the bow 20 of the boat 16 is disposed at the first portion 20 while the aft end 22 of the boat 16 is disposed at the second end portion 22.

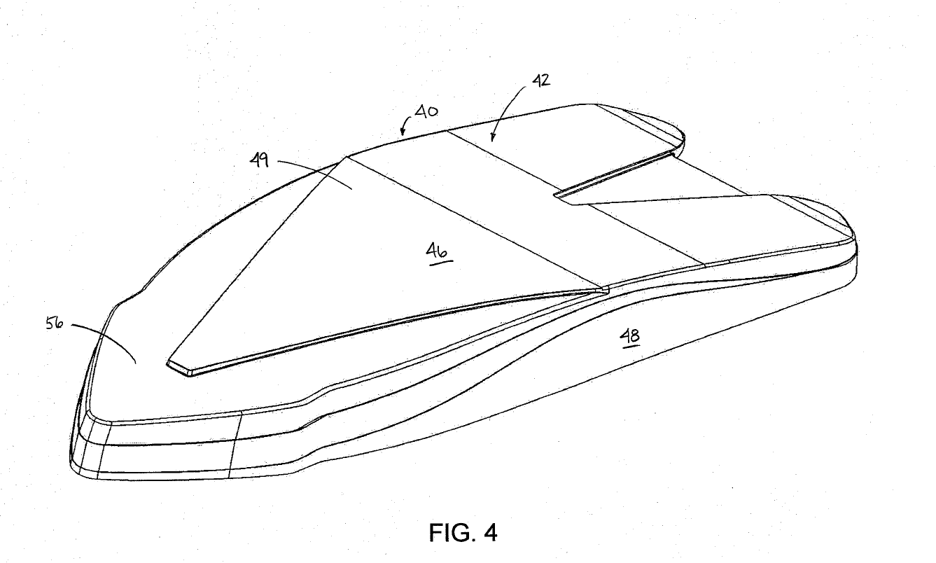

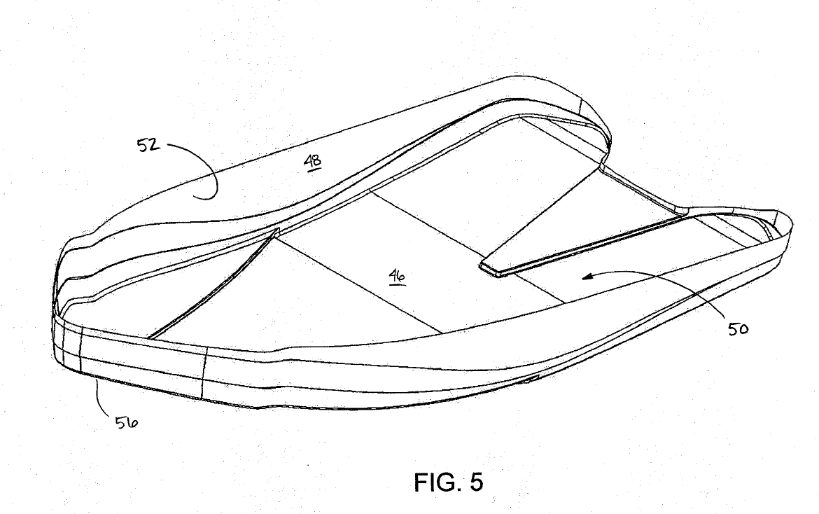

Referring now to FIGS. 1-5, the cover assembly 14 is shown. The cover assembly 14 is adapted for movement between a raised position (shown in FIG. 1) and a lowered position (shown in FIG. 2). The cover assembly 14 includes a cover, generally designated 40, having a first portion 42 and a second portion 44. In the subject embodiment, the first portion 42 is an upper portion while the second portion 44 is a lower portion that is disposed underneath the first portion 42.

In the subject embodiment, the first portion 42 of the cover 40 is manufactured from a material having a first stiffness. The first material of the first portion 42 is rigid or self-supporting. In one embodiment, the first material is a fiber glass material. The first portion 42 of the cover 40 includes a top wall 46 and a plurality of sides 48 that extend downwardly from the periphery of the top wall 46. As the first portion is made of a hard material such as fiber glass, an upper surface 49 of the top wall 46 of the first portion 42 can be used to display advertisements.

The top wall 46 and the plurality of sides 48 of the cover 40 cooperatively define a cavity 50 having an opening 52. In the subject embodiment, the cavity 50 is adapted to receive a top portion 54 (shown in FIG. 1) of the boat 16. In order to be disposed over the top portion 54 of the boat without damaging the boat 16, there is a clearance disposed between the periphery of the cavity 50 as defined by the plurality of sides 48 and the outer periphery of the hull 18 of the boat 16.

In one embodiment, the clearance includes a bow clearance, which is disposed between the bow 20 of the boat 16 and a forward end 56 of the cover 40, and an aft end clearance, which is disposed between the aft end 22 of the boat and a rearward end 57 of the cover 40. In one embodiment, the bow clearance is greater than the aft end clearance. This larger clearance between the bow of the boat 16 and the forward end 56 of the cover 40 allows the cover 40 to be positioned over the top portion 46 of the boat 16 when the top portion 56 includes a trolling motor 58 (shown in FIG. 1) mounted and/or stored at the bow 20 of the boat 16.

As there is a clearance disposed between the plurality of sides 48 of the first portion 42 of the cover 40 and the hull 18 of the boat 16, the second portion 44 is adapted to block the clearance at the opening 54 of the cavity 50. By blocking the clearance between the periphery of the cavity 50 and the outer periphery of the hull 18 of the boat, the risk of road debris entering into the boat 16 through the clearance when the boat 16 is being transported in the trailer assembly 10 is greatly reduced.

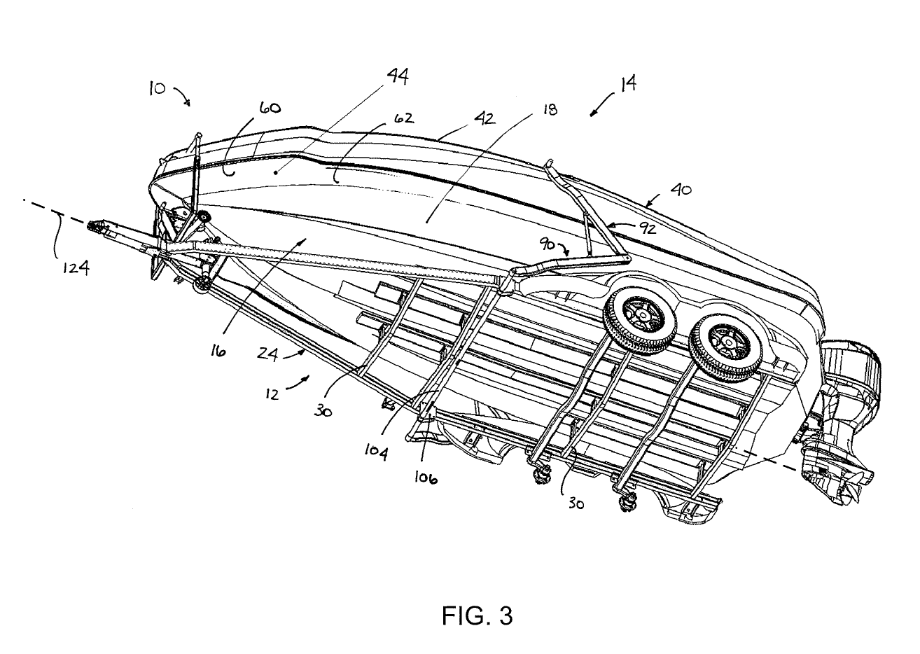

As best shown in FIG. 3, the second portion 44 includes an outer portion 60 and an inner portion 62. The outer portion 60 is engaged with the plurality of sides 48 of the first portion 42 of the cover 40. The inner portion 62 of the second portion 44 is adapted for engagement with the outer periphery of the hull 18 of the boat 16.

In the subject embodiment, the second portion 44 is a skirt that is manufactured from a second material having a second stiffness. In the subject embodiment, the second stiffness of the second material is less than the first stiffness of the first material. In one embodiment, the second material is a flexible material such as canvas, polyester, nylon, vinyl, polymeric film, etc. In one embodiment, the inner portion 62 of the skirt 44 includes a drawstring closure that is adapted to cinch the inner portion 62 of the skirt 44 around the hull 18 of the boat 16. In another embodiment, the inner portion 62 includes an elastic material that extends about the perimeter of the inner portion 62 and that is adapted to form a seal around the perimeter of the boat 16.

Referring again to FIGS. 1 and 2, the cover assembly 14 is mounted to the frame 24 by a first lifting arm, generally designated 64, and a second lifting arm, generally designated 66. In the subject embodiment, the cover assembly 14 is mounted to the frame 24 by a first plurality of lifting arms 64 and a second plurality of lifting arms 66. The first plurality of lifting arms 64 is disposed at the first end portion 32 while the second plurality of lifting arms 66 is disposed between the first end portion 32 and the second end portion 34.

In the subject embodiment, the first and second pluralities of lifting arms 64, 66 are assist devices. The first and second pluralities of lifting arms 64, 66 are adapted to counter the effects of the weight of the cover assembly 14 so that the cover assembly 14 can be manually raised and lowered by an operator of the trailer assembly 10. When the cover assembly 14 is manually raised by the operator, the first and second pluralities of lifting arms 64, 66 extend in response to this manual operation. This extension of the first and second pluralities of lifting arms 64, 66 in response to the manual operation will be referred to in the present disclosure as “manual extension” or variations thereof. Similarly, when the cover assembly 14 is manually lowered by the operator, the first and second lifting arms 64, 66 retract in response to this manual operation. This retraction of the first and second pluralities of lifting arms 64, 66 in response to the manual operation will be referred to in the present disclosure as “manual retraction” or variations thereof. In the subject embodiment, the first and second pluralities of lifting arms 64, 66 are adapted to hold the cover assembly 14 in any position between the raised and lowered position.

Referring now to FIGS. 1, 2 and 6, the first lifting arm 64 is an actuator that is capable of movement in a linear direction. In the subject embodiment, the linear movement of the first lifting arm 64 is in a generally vertical direction. The first lifting arm 64 extends and retracts to raise and lower the cover assembly 14. The first lifting arm 64 is extendable to a maximum length L₁ (shown in FIG. 1) and retractable to a minimum length L₂ (shown in FIG. 2).

In the subject embodiment, the first lifting arm 64 is a gas spring having a tube member 68 and a piston rod 70. The tube member 68 is filled with a gas such as nitrogen. The piston rod 70 is disposed within a bore of the tube member 68 and moves relative to the tube member 70 in the linear direction.

The first lifting arm 64 includes a first axial end portion 72 and an oppositely disposed second axial end portion 74. In the subject embodiment, the first axial end portion 72 is disposed on the tube member 68 and is connectedly engaged to the first end portion 32 of the frame 24. In one embodiment, the first axial end portion 72 is welded to the first end portion 32 of the frame 24.

The second axial end portion 74 is disposed on the piston rod 70 and is connectedly engaged to first portion 42 of the cover 40. In the subject embodiment, the second axial end portion 74 is engaged to the cover 40 such that the cover 40 can pivot about the second axial end portion 74.

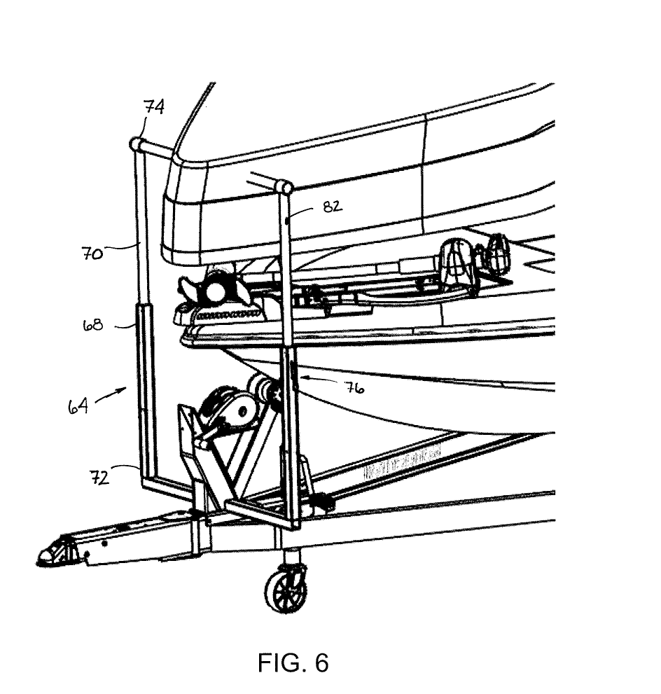

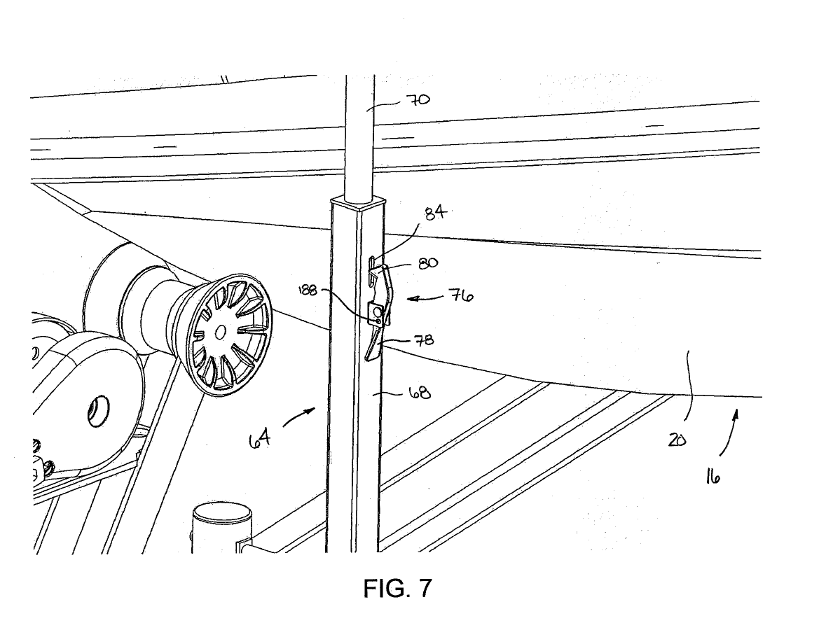

Referring now to FIGS. 6 and 7, the first lifting arm 64 includes a lock 76. The lock 76 is adapted to prevent movement in the linear direction of the lifting arm 64.

The lock 76 includes a handle portion 78 and a locking portion 80. In the subject embodiment, the locking portion 80 is adapted be received within a slot 82 (shown in FIG. 6) in the piston rod 70 through an aperture 84 in the tube member 68. In one embodiment, the slot 82 is disposed near the second axial end portion 74 of the piston rod 70. In this embodiment, the locking portion 80 engages the slot 82 when the piston rod 70 is in a retracted position such as when the cover assembly 14 is in the lowered position (shown in FIG. 2). With the locking portion 80 disposed in the slot 82, the forward end 56 of the cover assembly 14 cannot be raised without manually actuating the lock 76 to a release position.

In another embodiment, a second slot is disposed on the piston rod 70 at a location opposite the slot 82. In this embodiment, the locking portion 80 engages the second slot when the piston rod 70 is in an extended position such as when the cover assembly 14 is in the raised position (shown in FIG. 1). With the locking portion 80 disposed in the second slot, the forward end 56 of the cover assembly 14 cannot be lowered.

In one embodiment, the lock 76 is manually engaged and disengaged with the slot 82 in the piston rod 70. In another embodiment, the lock 76 includes a spring that biases the locking portion 80 of the lock 76 toward the piston rod 70.

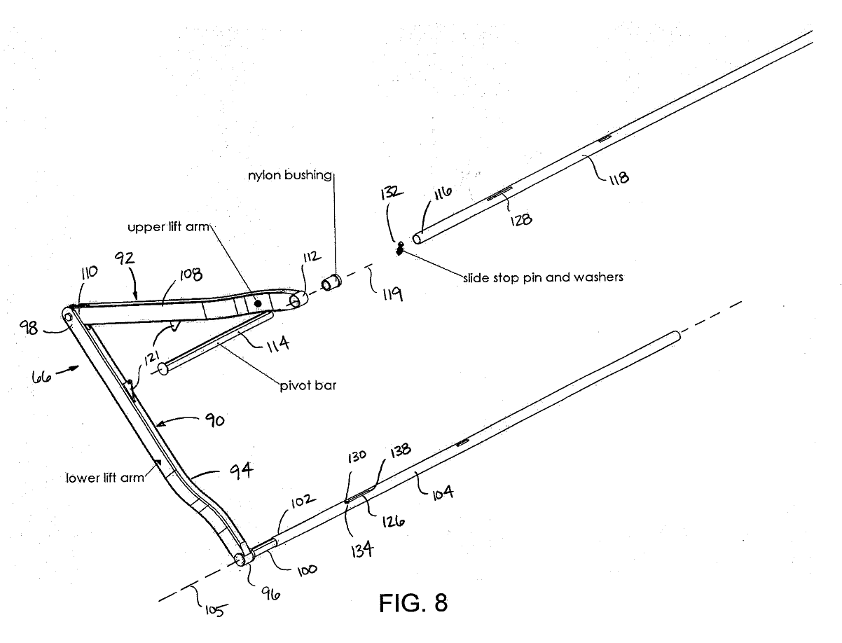

Referring now to FIGS. 1 and 8, the second lifting arm 66 is shown. The second lifting arm 66 includes a first arm assembly, generally designated 90, that is in articulated engagement with a second arm assembly, generally designated 92. In the subject embodiment, the first arm assembly 90 is engaged with the frame assembly 12 while the second arm assembly 92 is engaged with the cover assembly 14. An actuator 93 (shown in FIG. 1) is engaged with the first and second arm assemblies 90, 92. In the subject embodiment, the actuator 93 is a gas spring.

The actuator 93 manually extends and manually retracts to raise and lower the cover assembly 14 relative to the frame assembly 12. The second lifting arm 66 is extendable to a maximum length L₃ (shown in FIG. 1) and retractable to a minimum length L₄ (shown in FIG. 2). The difference between the extended length L₃ and the retracted length L₄ of the second lifting arm 66 is greater than the difference between the extended length L₁ and the retracted length L₂ of the first lifting arm 64. This difference allows the cover assembly 14 to be raised in a vertical direction until the first lifting arm 64 reaches the maximum extended length L₁ and then rotated about the forward end 56 of the cover 40 (e.g., at axis 120) until the second lifting arm 66 reaches the maximum extended length L₃.

The first arm assembly 90 includes a first arm 94, which includes a first end 96 and an oppositely disposed second end 98, and a first pivot bar 100. The first pivot bar 100 is adapted to connect the first arm assembly 90 to the frame assembly 12. In the subject embodiment, first pivot bar 100 is adapted to be received through the first end 96 of the first arm 94 and into an opening disposed on an end 102 of a first mounting bar 104, which is rigidly fixed to the frame assembly 12. In one embodiment, the first mounting bar 104 is mounted to the frame assembly 12 by a plurality of mounting brackets 106 (shown in FIG. 3). The first pivot bar 100 is adapted for selective linear movement relative to the first mounting bar 104 along axis 105.

The second arm assembly 92 includes a second arm 108, which includes a first end 110 and an oppositely disposed second end 112, and a second pivot bar 114. The second pivot bar 114 is adapted to connect the second arm assembly 92 to the cover assembly 14. In the subject embodiment, the second pivot bar 114 is adapted to be received through the second end 112 of the second arm 108 and into an opening disposed on an end 116 of a second mounting bar 118, which is rigidly fixed to the cover assembly 14. The second pivot bar 114 is adapted for selective linear movement relative to the second mounting bar 118 along axis 119.

The second end 98 of the first arm 94 is pivotally connected with the first end 110 of the second arm 108. This pivotal connection provides the articulation between the first arm 94 and the second arm 108. As the cover assembly 14 is raised from a lowered position (shown in FIG. 2) to a raised position (shown in FIG. 1), the first arm 94 pivots about the first end 96 of the first arm 94 while the second arm 108 pivots about the first end 110 of the second arm 108, which is connectedly engaged with the second end 98 of the first arm 94. As the difference between the extended length L₃ and the retracted length L₄ of the second plurality of lifting arms 66 is greater than the difference between the extended length L₁ and the retracted length L₂ of the first plurality of lifting arms 64, the cover assembly 14 pivots about an axis 120 defined through the second axial end portions 74 of the first plurality of lifting arms 64 during full extension of the second plurality of lifting arms 66.

Each of the first and second arms 94, 108 include a bracket 121 disposed between the first ends 96, 110 and the second ends 98, 112, respectively. Each bracket 121 provides a mount for an end of the actuator 93 (shown in FIG. 1).

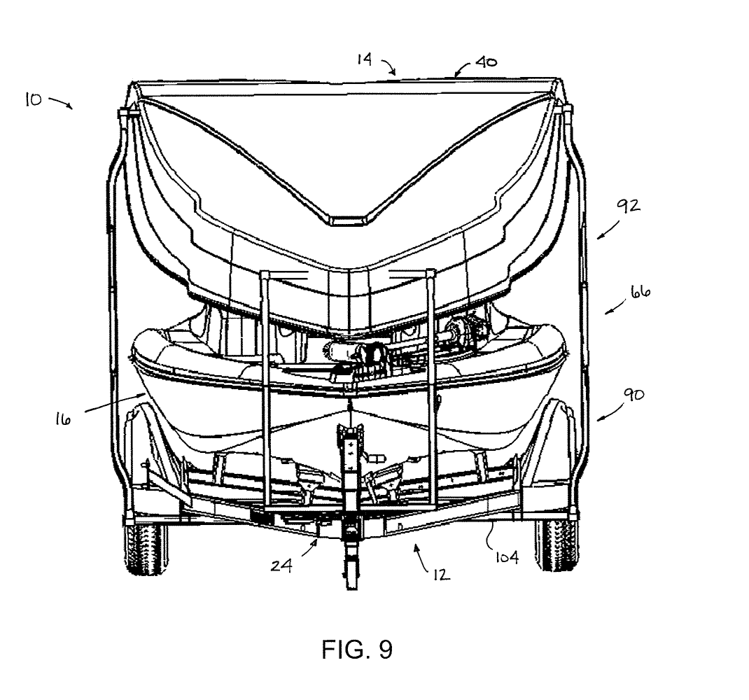

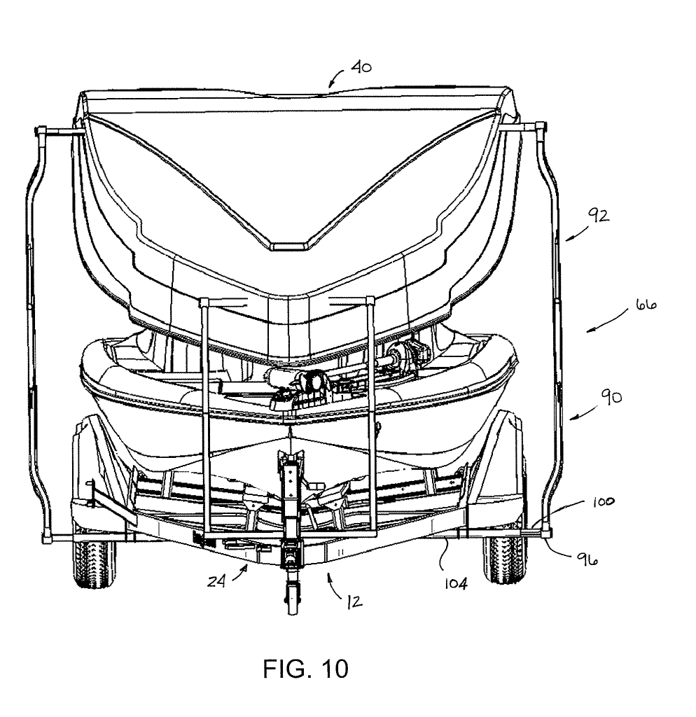

Referring now to FIGS. 9 and 10, the second lifting arm 66 is selectively laterally extendable relative to the frame 24. This selective lateral extension of the second lifting arm 66 may be advantageous as it allows for greater clearance between the boat 16 and the second lifting arm 66 of the frame assembly 12 as the boat 16 is being positioned onto or removed from the trailer assembly 10. In the subject embodiment, each of the second lifting arm 66 extends outwardly from a longitudinal axis 124 (shown in FIG. 3) of the frame 24 in a direction that is generally perpendicular to the longitudinal axis 124. The second lifting arm 66 is selectively moveable between a towing position (shown in FIG. 9) and a loading position (shown in FIG. 10). It will be understood, that the term loading position is not limited to when the boat 16 is being loaded onto the trailer assembly 10 as the loading position could also be used to unload the boat 16 from the trailer assembly 10.

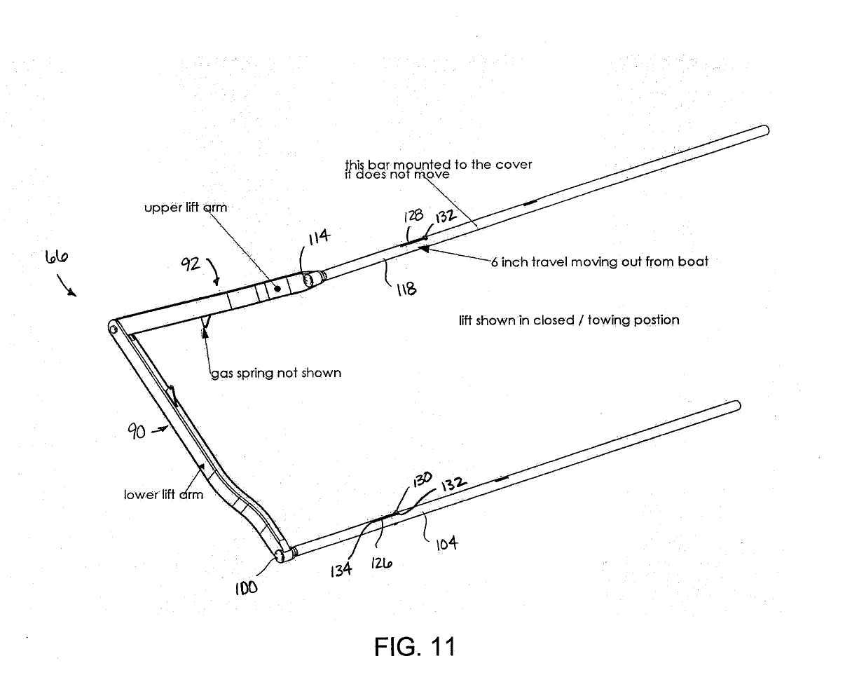

Referring now to FIGS. 9 and 11, the second lifting arm 66 is shown in the towing position. In the towing position, the maximum width of the trailer assembly 10 is less than or equal to about 102 inches. In the towing position, the first and second arm assemblies 90, 92 are laterally retracted such that each of the second plurality of lifting arms 66 is disposed adjacent to the frame 24. In this position, each of the first and second pivot bars 100, 114 is retracted within the mounting bars 104, 118, respectively.

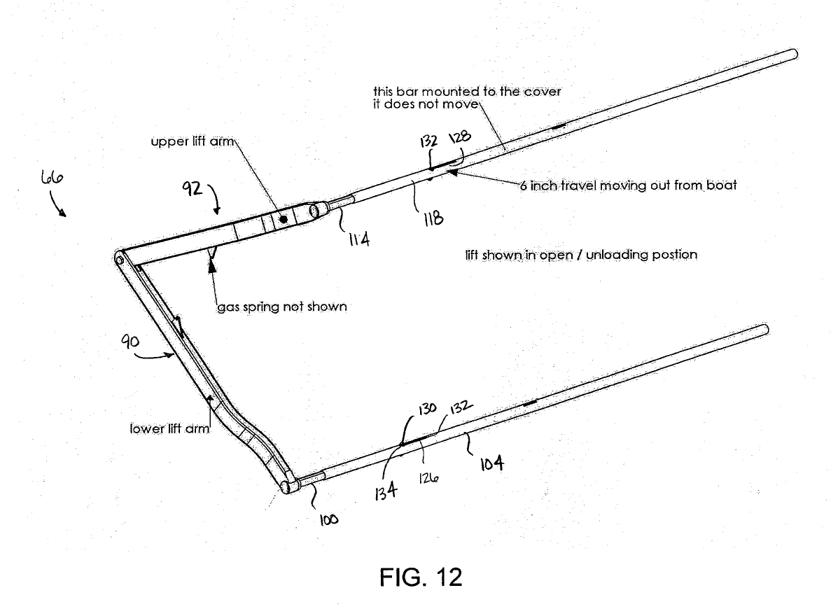

Referring now to FIGS. 10 and 12, the second lifting arm 66 is shown in the loading position. In the loading position, the first and second arm assemblies 90, 92 are laterally extended from the frame 24. In this position, each of the first and second pivot bars 100, 114 is extended from the first and second mounting bars 104, 118, respectively.

Referring now to FIGS. 8, 11, and 12, the first and second mounting bars 104, 118 include first and second thru-slots 126, 128, respectively, that are adapted to receive first and second pins 130, 132, respectively. The first and second pins 130, 132 are connectedly engaged with ends of the first and second pivot bars 100, 114, respectively.

The operation of the lateral extension of the second lifting arm 66 will now be described. As the first arm assembly 90 is similar to the second arm assembly 92, only the movement of the first arm assembly 90 will be described for ease of description purposes only. It will be understood, however, that as the first arm assembly 90 is selectively moved between the towing position and the loading position, the second arm assembly 92 is also moved.

The engagement between the first pin 130 and the first pivot bar 100 and the disposition of the first pin 130 in the first thru-slot 126 in the first mounting bar 104 provide for limited axial movement of the first pivot bar 100 relative to the first mounting bar 104. With the first arm assembly 90 in the towing position, the first pin 130 is disposed adjacent to a first end 134 of the first thru-slot 126. The first arm assembly 90 can then be selectively moved in a direction away from the first end 134 of the first thru-slot 126 until the first pin 130 is disposed adjacent to a second end 136, which is oppositely disposed from the first end 134, of the first thru-slot 126 to the loading position.

In one embodiment, the first and second arm assemblies 90, 92 extend a lateral distance outwardly from the frame 24 that is greater than or equal to about 4 inches. In another embodiment, the first and second arm assemblies 90, 92 extend a lateral distance outwardly from the frame 24 that is greater than or equal to about 6 inches. In another embodiment, the first and second arm assemblies 90, 92 extend a lateral distance outwardly from the frame 24 that is in the range of about 6 inches to about 12 inches. In another embodiment, the first and second arm assemblies 90, 92 extend a lateral distance outwardly from the frame 24 such that the width of the trailer assembly 10 in the loading position is greater than about 102 inches.

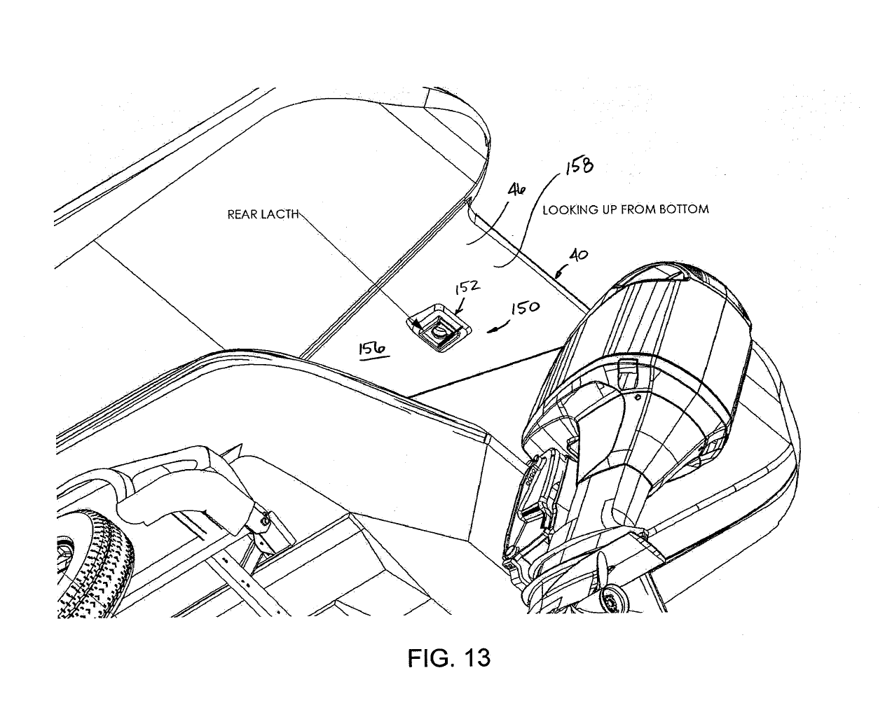

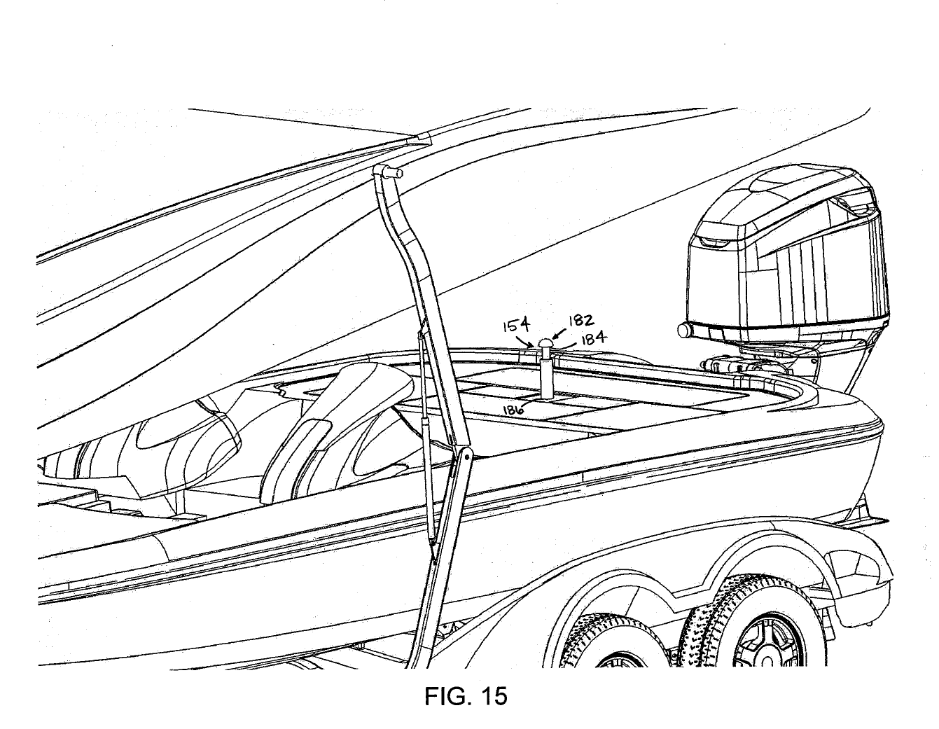

Referring now to FIGS. 13-15, a latch assembly, generally designated 150 is shown. The latch assembly 150 includes a latch mechanism, generally designated 152, and a catch 154 (shown in FIG. 15).

The latch mechanism 152 is disposed on a bottom surface 156 of the top wall 46 of the cover 40 and is adapted to secure the cover assembly 14 in the lowered position (shown in FIG. 2). In the subject embodiment, the latch mechanism 152 is disposed at the rearward end 57 of the cover 40.

In the subject embodiment, the latch mechanism 152 includes a housing 160 having a base 162 and a plurality of sides 164 that extend downwardly from the base 162. The base 162 and the plurality of sides 164 cooperatively define a recess 166 having an opening 168.

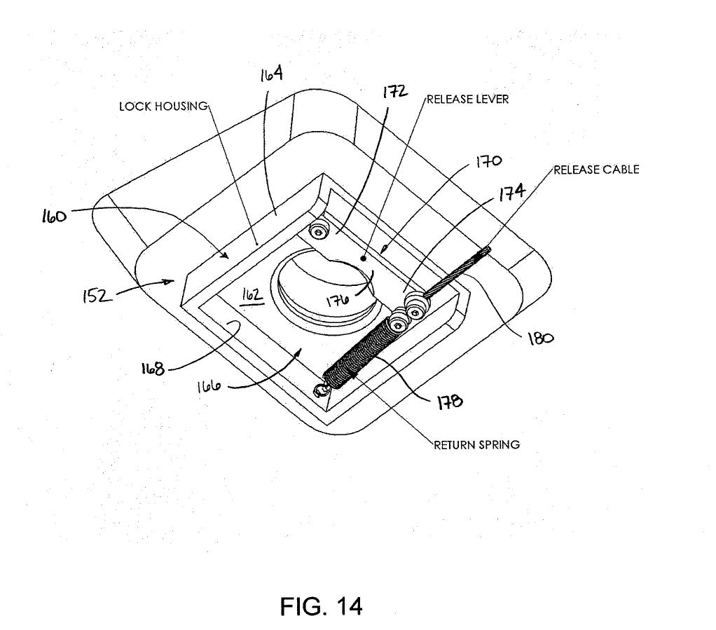

The latch mechanism 152 further includes a lever 170 having a first end portion 172, an oppositely disposed second end portion 174 and a latching portion 176 disposed between the first and second end portions 172, 174. In the subject embodiment, the first end portion 172 is pivotally connected to the base 162 of the housing 160. The second end portion 174 is connected to a spring member 178 that biases the lever 170 to a closed position (shown in FIGS. 14 and 15). In the subject embodiment, the second end portion 174 is also connected to a release cable 180. The release cable 180 exits the housing 160 through the opening 168 and is adapted to selectively rotate the lever 170 about the first end portion 172 so as to move the lever 170 to an open position.

The catch 154 (shown in FIG. 15) is adapted for selective engagement with the latching portion 176 of the lever 170 of the latch mechanism 152. The catch 154 includes a top portion 182 having a lip 184. In the subject embodiment, the top portion 182 of the catch 154 includes an end that is generally tapered or rounded. The end is disposed immediately above the lip 184.

As the end of the top portion 182 of the catch 154 engages the latching portion 176 of the lever 170, the tapered or rounded shape of the end of the top portion 182 biases lever 170 in an outward direction until the lever 170 is disposed beneath the lip 184. With the lever 170 disposed beneath the lip 184, the spring member 178 biases the lever 170 toward the closed position such that the latching portion 176 of the lever 170 is disposed under the lip 184 of the catch 154. With the latching portion 176 disposed under the lip 184 of the catch 154 with the lever 170 in the closed position, the cover 40 cannot be raised until the release cable 180 is actuated to move the lever 170 to the open position.

In the subject embodiment, the catch 154 is a cylindrical post that is adapted to fit in a receptacle 186 on the boat 16. In one embodiment, the receptacle 186 is the receptacle used to mount a seat post on the deck of the boat 16. To install the catch 154, the seat post is removed from the receptacle 186 and an end portion of the catch 154, which is disposed opposite the top portion 182, is inserted in to the receptacle. The catch 154 locks into the receptacle by a conventional snap fit connection. For example, a snap-fit connection suitable for use with the catch 154 and the receptacle 186 is described in U.S. Pat. No. 5,431,362, which is hereby incorporated by reference in its entirety.

In one embodiment, the latch assembly 150 includes a sensor. The sensor is adapted to activate an alarm if the release cable 180 of the latch mechanism 152 is actuated without first deactivating the sensor. In one embodiment, a remote control is in communication with the sensor such that the sensor can be deactivated using the remote control. In the event that the alarm is activated by the sensor, the alarm can be deactivated by the remote control. This sensor may be advantageous to prevent others from raising the cover assembly 14 on the trailer assembly 10.

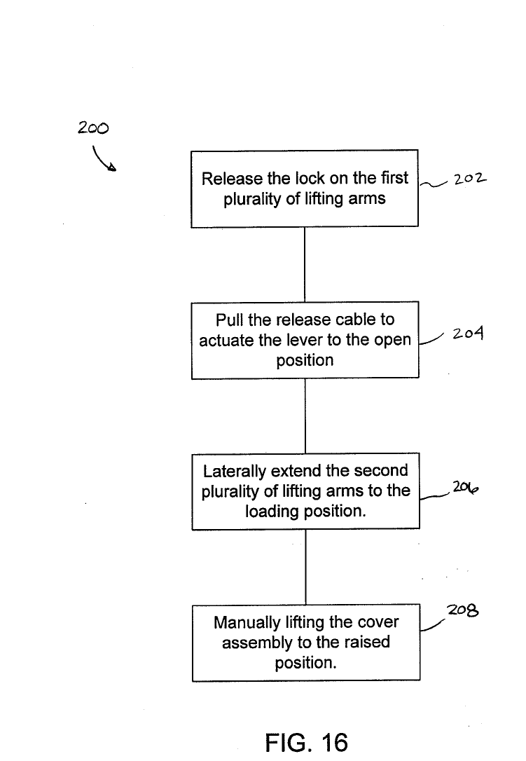

Referring now to FIG. 16, a method 200 for raising the cover assembly 14 relative to the frame assembly 12 from the lowered position (shown in FIG. 2) to the raised position (shown in FIG. 1) will now be described. With the cover assembly 12 in the lowered position, the handle portion 78 of the lock 76 is actuated so as to disengage the locking portion 80 from the slot 82 in the piston rod 70 of the first plurality of lifting arms 64 in step 202. For security purposes, a pad lock can be mounted through a hole 188 (shown in FIG. 7) of the lock 76 to prevent the handle portion 78 from being actuated.

In step 204, each of the first and second arm assemblies 90, 92 of the second plurality of lifting arms 66 is pulled laterally outward from the frame 24 of the frame assembly 12 to the loading position. In the subject embodiment, each of the first and second arm assemblies 90, 92 is pulled outwardly in a direction that is generally perpendicular to the longitudinal axis 124 of the frame 24. The first and second arm assemblies 90, 92 can be pulled outwardly from the frame 24 until the first and second pin 130, 132 abut an end of the first and second thru-slots 126, 128 of the first and second mounting bars 104, 118.

In step 206, the release cable 180 of the latch assembly 150 is actuated. The actuation of the release cable 180 rotates the lever 170 about the first end portion 172 and disengages the latching portion 176 of the lever 170 from the lip 184 of the catch 154. In one embodiment, the sensor of the latch assembly 150 is disengaged in order to deactivate a security system.

With the locking portion 80 disengaged from the piston rod 70 of the first plurality of lifting arms 64 and the latch mechanism 152 disengaged from the catch 154, the cover assembly 14 can be manually raised to the raised position in step 208. In the subject embodiment, in order to raise the cover assembly 14, the forward end 56 of the cover 40 is manually raised in a linear direction (e.g., vertical) with the assistance of the first plurality of lifting arms 64. Preferably, the forward end 56 of the cover 40 is raised high enough above the front of the boat 16 so that the cover 40 can be subsequently pivoted upwards about the axis 120 without causing interference between the front of the boat 16 and the forward end 56 of the cover 40. Once the forward end 56 has been manually lifted so that the first plurality of lifting arms 64 are at their maximum extended length L₁, the rearward end 57 of the cover 40 is manually lifted with the assistance of the second plurality of lifting arms 66, so that the rearward end 57 of the cover 40 pivots upwardly about the axis 120. In one embodiment, the cover 40 is raised until the second plurality of lifting arms 66 reaches their maximum extended length L₃.

With the cover assembly 14 in the raised position relative to the frame assembly 12, the boat 16 can be unloaded from the trailer assembly 10 or loaded onto the trailer assembly 10.

It will be understood that scope of the present disclosure is not limited to the steps described in the above method 200 being completed in the order described above. It is within the scope of the present disclosure for the steps 202 and 204 to be completed in any order and for the step 206 to be completed in any order before or after the cover is manually lifted.

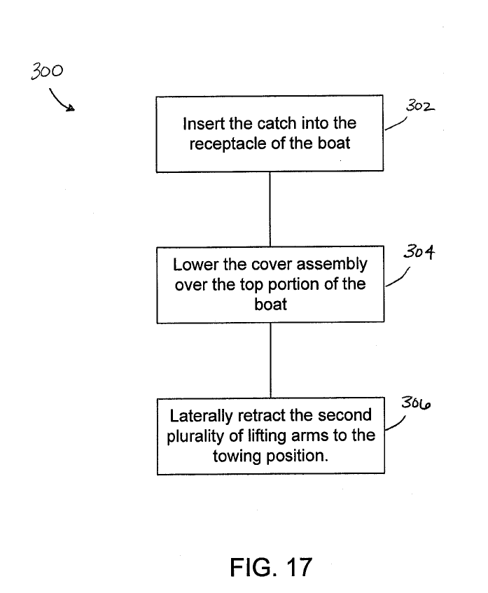

Referring now to FIG. 17, a method 300 for lowering the cover assembly 14 relative to the frame assembly 12 over the top portion 54 of the boat 16 will be described. In step 302, the catch 152 is inserted and secured into the receptacle 186 on the boat 16. In step 304, the cover assembly 14 is manually lowered over the top portion 54 of the boat 16 to the lowered position until the latching mechanism 152 engages the catch 154 and the locking portion 80 engages the piston rod 70 of the first plurality of lifting arms 64.

In step 306, each of the first and second arm assemblies 90, 92 are pushed inwardly toward the frame 24 of the frame assembly 12 to the towing position. The first and second arm assemblies 90, 92 can be pushed inwardly toward the frame 24 until the first and second pin 130, 132 abut an end of the first and second thru-slots 126, 128 of the first and second mounting bars 104, 118.

With the first and second arm assemblies 90, 92 of the second plurality of lifting arms 66 in the towing position and the latch mechanism 152 engaged with the catch 154, the trailer assembly 10 can be transported to the desired location.

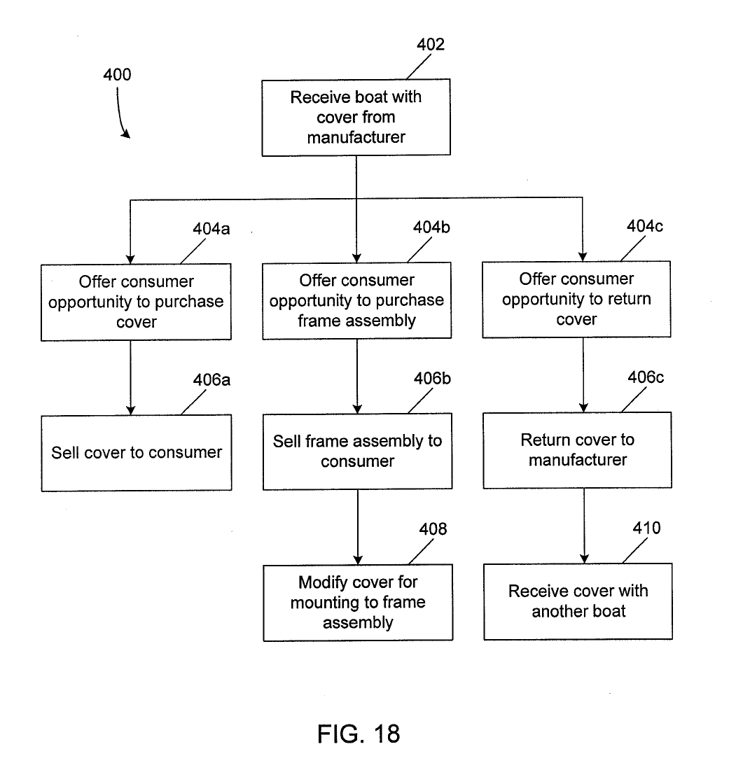

Referring now to FIG. 18, a method 400 for supplying the cover 40 to a consumer is shown. In step 402, the cover 40 is received by a dealer with the boat 16 purchased by a consumer. In one embodiment, the cover 40 is used to cover the top portion 54 of the boat 16 and to protect the interior of the boat 16 during shipping to the dealer. In one embodiment, the cover 40 does not include any of the hardware that would allow the cover 40 to be mounted to the frame assembly 12.

In step 404, the dealer provides a plurality of choices to the consumer. In step 404a, the dealer offers the consumer an opportunity to purchase the cover 40. If the consumer accepts this choice, in step 406a, the dealer sells the cover to the consumer.

In step 404b, the dealer offers the consumer an opportunity to purchase the cover 40 and the frame assembly 12. If the consumer accepts this choice, the dealer would sell the trailer assembly 10 to the consumer in step 406b and modify the cover 40 in step 408 so that the cover 40 can be mounted to the frame assembly 12 of the trailer assembly 10. In one embodiment, the cover 40 would be modified by rigidly mounting the second mounting bar 118 to the cover 40. In another embodiment, the second mounting bar 118 may be mounted to the cover 40 at the time the cover 40 is sent to the consumer with the boat 16. In this embodiment, the modification of the cover 40 could include removing end plugs from the ends 116 of the second mounting bar 118 so that the second pivot bar 114 can be inserted into the opening of the end 116 of the second mounting bar 118.

In step 404c, the dealer offers the consumer an opportunity to return the cover 40. If the consumer makes this decision, the dealer returns the cover 40 to the boat manufacturer in step 406c. After the manufacturer receives the cover 40 from the dealer, the cover 40 can be shipped back to the dealer with another boat 16 in step 410.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A trailer assembly comprising:
a cover assembly having a cover;
a frame assembly engaged with the cover assembly and including:
a frame; and
a lifting arm having a first end engaged to the frame and a second end engaged to the cover, wherein the lifting arm is selectively laterally extendable from the frame.

2. A trailer assembly as claimed in claim 1, wherein the cover of the cover assembly includes a first portion made of a first material having a first stiffness and a second portion made of a second material having a second stiffness, wherein the second stiffness is less than the first stiffness.

3. A trailer assembly as claimed in claim 2, wherein the second portion of the cover includes an outer portion and an inner portion with the inner portion being adapted for engagement with an outer periphery of the boat.

4. A trailer assembly as claimed in claim 1, wherein the cover assembly includes a latch assembly having a latch mechanism that is adapted to secure the cover assembly in a lowered position.

5. A trailer assembly as claimed in claim 4, wherein the latch assembly includes a catch that is adapted for mounting in a receptacle of the boat.

6. A trailer assembly as claimed in claim 4, wherein the latch mechanism includes a lever that is adapted to engage a lip on a catch.

7. A trailer assembly as claimed in claim 4, wherein the latch assembly includes a sensor that is adapted to activate an alarm if the latch mechanism is actuated.

8. A trailer assembly as claimed in claim 7, wherein a remote is communication with the sensor in order to deactivate the sensor or the alarm.

9. A trailer assembly as claimed in claim 1, wherein the lifting arm includes a first arm assembly in articulated engagement with a second arm assembly.

10. A trailer assembly as claimed in claim 9, wherein a gas spring is in connected engagement with the first arm assembly and the second arm assembly.

11. A cover assembly for covering a boat, the cover assembly comprising:
a first portion having a top wall and a plurality of sides, the top wall and the plurality of sides cooperatively defining a cavity that is adapted to receive a top portion of a boat, wherein the first portion is made of a material that is self-supporting; and
a second portion having an outer portion and an inner portion, the outer portion being engaged to the plurality of sides of the first portion and the inner portion being adapted for engagement with a hull of a boat, wherein the second portion is made of a material having a stiffness that is less than the material of the first portion.

12. A cover assembly for covering a boat as claimed in claim 11, wherein the cover assembly is adapted to provide a clearance between the plurality of sides of the first portion and the hull of the boat.

13. A cover assembly as claimed in claim 12, wherein the cover assembly is adapted to provide a greater clearance between the plurality of sides and the hull at a bow of the boat than at an aft end of the boat.

14. A method for raising a cover of a trailer assembly, the method comprising:
raising a cover assembly in a linear direction relative to a frame assembly; and
pivoting the cover assembly about a forward end of the cover assembly.

15. A method for raising a cover assembly of a trailer assembly as claimed in claim 14, wherein the linear direction is generally vertical.

16. A method for raising a cover assembly of a trailer assembly as claimed in claim 15, wherein the cover assembly is engaged with the frame assembly by a first lifting arm disposed at a forward end of the cover assembly and a second lifting arm disposed between the forward end and a rearward end of the cover assembly.

17. A method for raising a cover assembly of a trailer assembly as claimed in claim 16, wherein the second lifting arm is articulated.

18. A method for raising a cover assembly of a trailer assembly as claimed in claim 16, the method further comprising laterally extending the second lifting arm to a loading position.

19. A method for raising a cover assembly of a trailer assembly as claimed in claim 18, the method further comprising releasing a lock on the first lifting arm.

20. A method for raising a cover assembly of a trailer assembly as claimed in claim 19, the method further comprising actuating a latch mechanism disposed on the cover assembly to an open position.
